(19) United States
(12) Patent Application Publication
(10) Pub. No.: US 2006/0266482 A1
(43) Pub. Date: Nov. 30, 2006

(54) Computer Monitor Privacy/Glare Curtain/Shield

(76) Inventor: Charles Henry Montano, Gardena, CA (US)

Correspondence Address: U. S. METALCRAFT, INC., 16938 SOUTH BROADWAY, GARDENA, CA, 90248, US

(21) Appl. No.: 10/908,769

(22) Filed: May 25, 2005

(51) Int. Cl. E06B 3/94

(52) U.S. Cl. 160/134

(57) ABSTRACT

A device to provide privacy, reduce glare, and provide some decorative distinction to the computer/notebook computer monitor. The device can be used with a wide variety of notebook computer and computer monitor sizes and comprises of mounting brackets, curtains/shields, and curtain/shield weights.

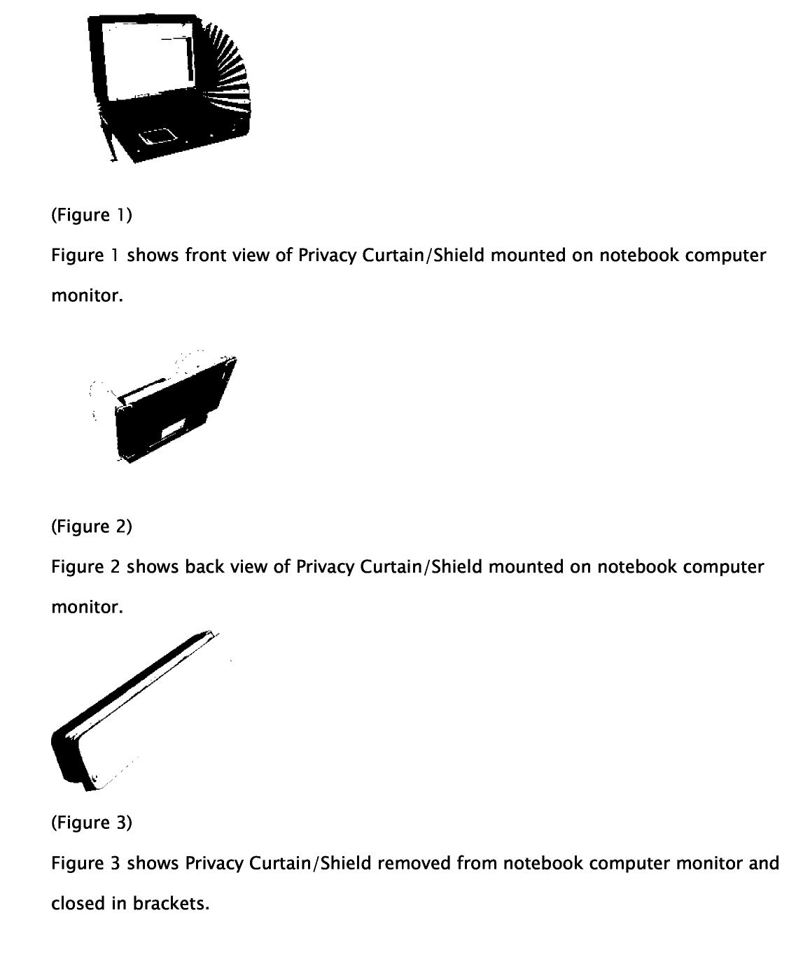

The device was developed to help maintain privacy, reduce glare, and provide some decorative distinction to the computer/notebook computer monitor.

The device assembly consists primarily of three components: 2 ea brackets (When not directly mounted into the monitor housing), 2 ea curtains/shields, and 2 ea curtain/shield weights.

The curtain/shield is contained in brackets secured on each side of a computer/notebook computer monitor or can be mounted directly in the monitor housing when facilitated. The brackets can be secured by either permanent or temporary means. When opened product helps to maintain privacy and reduce glare relating to the monitor. The curtain/shield will open by manual means or by gravity. When not in use the brackets can be removed from the monitor and attached to each other enclosing the curtains allowing for easy storage.

The brackets, which house the curtain/shield, will be machined or extruded from plastic or metal and will enclose the curtain/shield completely when the curtain/shield is retracted/folded into the bracket. Color and design of the bracket will be added for aesthetic purposes. The curtain/shield will be fabricated from a durable material that will maintain its form and function as required for its intended use. Color and design will be added to the curtain/shield for aesthetic purposes.

What is claimed is:

1. A device for helping to maintain privacy, reduce glare, and provide decorative distinction to the computer/notebook computer monitor, comprising of 2 units located on each side of the computer/notebook computer monitor which house and allow for the curtain/shield to be opened, maintaining the location of the curtain/shield, and allowing for access to all computer devices.

2. The device as in claim 1, wherein the brackets are made of metal.

3. The device as in claim 1, wherein the brackets are made of plastic.

4. The device as in claim 1, wherein the curtain/shield is mounted directly within the monitor housing.

5. The device as in claim 1, wherein the curtain/shield is cut and formed in one piece to facilitate being fully housed in the brackets.

6. The device as in claim 1, wherein the curtain/shield is cut and formed in one piece to facilitate being fully housed in the monitor housing.

7. The device as in claim 1, wherein the curtain/shield is cut and scored to facilitate being fully housed in the brackets.

8. The device as in claim 1, wherein the curtain/shield is cut and scored to facilitate being fully housed in the monitor housing.

9. The device as in claim 1, wherein the curtains/shields are permanently mounted in the monitor housing.

10. The device as in claim 1, wherein the brackets are permanently mounted on the monitor housing.

11. The device as in claim 1, wherein the brackets are temporarily mounted on the monitor housing.

12. The device as in claim 1, wherein the device is mounted and of proper size as to limit the field of vision of outside entities.

13. The device as in claim 9, wherein the curtains/shields are mounted and of proper size as to limit the field of vision of outside entities.

14. The device as in claim 10, wherein the device is mounted and of proper size as to limit the field of vision of outside entities.

15. The device as in claim 11, wherein the curtain/shield is mounted and of proper size as to limit the field of vision of outside entities.
